(19) United States
(12) Patent Application Publication
(10) Pub. No.: US 2005/0186995 A1
(43) Pub. Date: Aug. 25, 2005

(54) Ergonomic apparatus for attachment to a mobile hand-held electronic device

(76) Inventor: Martha S. Gill, N. Andover, MA (US)

Correspondence Address: Sean D. Burdick, 21372 Avenida Manantial, Lake Forest, CA, 92630, US

(21) Appl. No.: 11/050,636

(22) Filed: Feb. 2, 2005

Related U.S. Application Data
(60) Provisional application No. 60/541,165, filed on Feb. 2, 2004.

(51) Int. Cl. G06K 7/10; G06K 9/22; H04M 1/00

(52) U.S. Cl. 455/575.1

(57) ABSTRACT

An ergonomic apparatus for attachment to a mobile hand-held electronic device. The apparatus comprises a deformable resilient body having a size approximately equal to, or greater than, the electronic device, at least one location dimensionally suited for easy grasping by a human hand, conspicuous features for easy visual identification, and a releasable fastener for attaching the body to the device. The fastener may comprise a hook and loop fastener, or may comprise a clip configured to maintain the body at a fixed or adjustable angle with respect to the device, thereby supporting the device in a usable position while resting on a horizontal surface.

This application claims benefit of Provisional Application No. 60/541,165 filed Feb. 2, 2004, which is hereby fully incorporated by reference herein as though set forth in full.

### BACKGROUND

1. Field of the Invention

This invention relates generally to accessories for mobile hand-held electronic devices, and more specifically to ergonomic apparatus used to facilitate handling, locating and identifying hand-held computerized products such as cell phones, personal digital assistants, remotes controls, video games, and mobile e-mail devices.

2. Related Art

Technological advances in the computer electronics industry are typically measured by trends such as reductions in product size, and improvements in processing speed. In terms of ergonomics, it is difficult to imagine any drawback to an improvement in processing speed, because consumers prefer products that process demands seemingly instantaneously. However, reductions in the physical size of a product, particularly one that is intended for manipulation by the human hand, are advantageous only up to a point. Beyond that point, the benefits of compacting a product into smaller and smaller sizes are outweighed by ergonomic problems such as locating, identifying, and handling the product.

Loss is the most frequent problem confronting users of hand-held products, particularly hand-held mobile electronic devices such as cellular telephones, personal digital assistants, remotes controls, video games, and mobile e-mail devices. Their small, streamlines designs make them susceptible to misplacement or accidental loss. Hand-held electronic products notoriously hide between sofa cushions, under car seats, in coat pockets, at the bottom of a purse, or in some other obscured location equally vexing to the user. Even when the device is left out in the open, the smaller it is, the more difficult it is to eyeball, and the easier it is to leave behind. The proliferation of these products and their commonality in design also lead to confusion. A user can easily mistake her device for that of another, or find herself juggling a trio of remote controls until finally identifying the right one for the job.

Other problems that arise from reductions in the size include difficulties in handling small-sized devices, particularly those equipped with manipulable keypads. In order not to obstruct a keypad, a user may grasp the sides of the device nimbly by the fingertips rather than securely in the palm of the hand. As a consequence, smaller devices are more likely to slip from the hand and fall to the ground. There are other problems as well. A cell phone user is often tempted to press a phone between her neck and shoulder in order to converse while both hands are freed for some other activity, such as driving a car. While this technique works fairly well for bulkier, conventional landline telephones, when applied to a hand-held cell phone the user risks losing her grip on the phone entirely.

It is apparent from the foregoing discussion that there presently exists a need to alleviate the ergonomic problems brought about by size reductions in hand-held electronic devices.

### SUMMARY

The present invention provides consumers with an ergonomically sound, and recognizably designed, apparatus for attachment to a mobile hand-held electronic device. The apparatus comprises a body having a size approximately equal to, or greater than, the electronic device, and a releasable fastener for attaching the body to the device. Preferably, the body comprises a deformable, resilient form having at least one location dimensionally suited for easy grasping by a human hand. In addition, the appearance of the body is preferably aesthetically pleasing, or otherwise readily visually recognizable to a user, such that the appearance provides an ergonomic function, namely, facilitating the user identifying and locating the device.

The invention is well-suited for use with any hand-held device, but has particular utility for use with mobile hand-held electronic devices, such as cellular telephones, personal digital assistants, remotes controls, video games, mobile e-mail devices, and the like, due to their value and to their susceptibility for becoming lost. In one embodiment, the body comprises a character recognizable by the user. In another embodiment, the body is removably attachable to the device, for example, by means of a hook and loop (i.e. Velcro® type) fastener. In another embodiment, the body is configured to support the device in a usable position while the body rests on a horizontal or vertical surface.

One object of the present invention is to provide the user with a means for easily identifying valuable personal property by sight. An advantage of the present invention is that it prevents small hand-held personal property from becoming lost among larger objects. Another advantage is that the invention provides an ergonomically sound grip that allows a user to grasp a hand-held device equipped with the invention more securely than the user could grasp an unequipped device. This facilitates normal use of the device, and minimizes the risk of a user losing her grip. Another advantage of the invention is that it provides a means for mounting a mobile electronic device without requiring the use of hands. Another advantage is that the invention provides protective padding to guard or cushion the device in the event the device is dropped.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating one embodiment of an apparatus according to the invention for attachment to a mobile hand-held electronic device.

FIG. 2 illustrates one embodiment of an apparatus according to the invention attached to a cellular telephone.

FIGS. 3A-3C illustrate different views of a releasable fastener employed in one embodiment of the present invention, the fastener comprising an angled clip.

FIGS. 4A-4B each illustrate an embodiment of a method according to the invention.

FIGS. 5A-5E depict different embodiments of an ergonomic apparatus according to the invention.

### DETAILED DESCRIPTION

In accordance with the object of the invention set forth above, preferred embodiments are now described in further detail, which, when read in conjunction with the claims and drawings, give broader meaning and scope to the spirit of the invention. As utilized herein, terms such as “about” and “substantially” and “approximately” are intended to allow some leeway in mathematical exactness to account for tolerances that are acceptable in the trade. Accordingly, any deviations upward or downward from the value modified by the terms “about” and “substantially” and “approximately” in the range of 1% to 25% should be considered to be explicitly within the scope of the stated value.

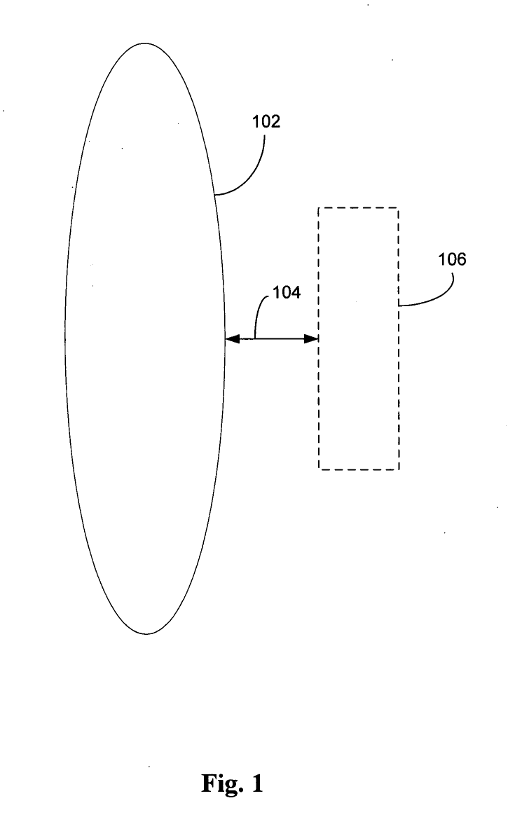

FIG. 1 illustrates an embodiment of an apparatus according to the invention. The apparatus comprises a body 102 and a releasable fastener 104 for attaching body 102 to a mobile device 106. A mobile device 106 is shown in phantom to indicate that such a device does not comprise an essential feature of the invention; rather, a device 106 comprises an object attachable to the apparatus. A mobile device 106 may be any moveable device, and is typically one transportable by a human hand. Ideally, the invention is used in conjunction with, and is well-suited for attachment to, a device 106 that comprises a mobile hand-held electronic device such as a cellular telephone, personal digital assistant, remote control, video game, mobile e-mail device (e.g. a “Blackberry” device manufactured by Research In Motion, Ltd.), and the like.

Body 102 may comprise any form having a size approximately equal to, or greater than, a device 106. Preferably, the size of body 102 exceeds the size of a device 106 by any amount from about 100% to about 400%, in order to provide a user with a larger visible target area when attempting to locate a device 106 by sight. Thus, attachment of body 102 to a device 106 ergonomically facilitates identification of a device 106 by a user. A user will also appreciate that by attaching body 102 to a device 106, the user may more easily locate a device 106 without the benefit of sight. A user who is blind, who is searching in the dark, or who is otherwise gioping for a device 106 without being able to see it, is thus more easily able to locate a device 106 because of its attachment to the larger body 102.

In one embodiment, body 102 comprises a deformable, resilient form. A deformable form may comprise any material that compresses somewhat under a force (such as a grasping force) to provide the grasper with a firmer grip. A resilient form may comprise any material that, after removal of the compressing force, tends to spring back or restore itself to its original uncompressed form. Examples of material suitable for making deformable, resilient forms include certain plastics, cloth, leather, vinyl, synthetic sponge, natural or synthetic rubber, and the like, or outer coverings or membranes composed of any of the foregoing that are filled with air, synthetic foam, shredded cloth, plastic balls, grain, beads, small particles, pillow stuffing, or other suitable material known in the art.

In another embodiment, body 102 includes at least one location dimensionally suited for easy grasping by a human hand. For example, this location may be substantially rounded or cylindrical in shape, and have a diameter between about four and about six inches. In another embodiment, body 102 may include at least one location dimensionally suited for compression between a user's neck and shoulder, such that, when so compressed, a transmitter or receiver of device 106 (such as a cell phone) are presented, respectively, to a user's mouth and ear. For example, this location may be any substantially rounded cylindrical, or rectangular configuration, may be the same location as the location suited for grasping, or may be a different location with the same or similar dimensions as the grasping location.

In general, body 102 adds bulk to a device 106. The added bulk reduces the probability that a device 106 will become lost under, behind, or within a larger object. The added bulk also functions as a protective pad to guard or cushion a device 106 in the event it is dropped onto a hard surface, such as cement or tile, that could damage the device. The added bulk also reduces the risk of a user dropping a device 106 by providing an ergonomically sound grasping area. An ergonomically sound grasping area allows a user to obtain a firm grip when handling a device 106, whether by hand, or by compressing the device between the neck and shoulders. By providing the user with a sound area for handling a device 106, the invention facilitates normal use of the device.

In another embodiment of an apparatus according to the invention, body 102 may be formed to support a device 106 in a functional position without a user holding body 102 by hand. For example, body 102 may be configured to rest on a horizontal surface such as a tabletop while supporting a cell phone or mobile e-mail device in a vertical position. In this fashion, a user may operate a cell phone having a speakerphone function, or read a visual display of a mobile e-mail device, without holding the device 106 in her hand. In another aspect, body 106 may be mountable on a vertical surface such as a wall or car window, while also supporting a device 106 in a functional position.

In another embodiment, the appearance of body 102 is readily visually recognizable to a user, such that the appearance provides an ergonomic function, namely, facilitating the user identifying and locating a device 106. This function may be achieved by means of an appearance that is aesthetically pleasing to the user, or it may be achieved by shapes or colors that are distinctive or otherwise attractive or conspicuous to a particular user. Irregular shapes (e.g. non-symmetrical geometries) and bright colors (e.g. blaze orange) are visually conspicuous. Or, the shape may resemble an object representing a user's hobby, leisure, or professional activity. Examples of such objects include a football, a baseball glove, a tennis racket; or a model vehicle such as an automobile, airplane, train, or spaceship; or a tool, an instrument, or other man-made device; or a fruit or vegetable; or an animal, humanoid, or fictional character; or a caricature of an historical personality. In one embodiment, aesthetically pleasing, or visually distinctive features, comprise one or more combinations of colors. In another embodiment, one or more of these combinations may comprise complimentary colors that tend to catch the eye.

It should be appreciated that the aforementioned aesthetic features are provided in an illustrative sense, and not by way of limitation. Moreover, these features, although aesthetic, also function to allow a user to readily recognize her personal property. This ability is particularly useful for users of mobile hand-held electronic devices, because these devices can have considerable value, and can at times be difficult to locate due to their relatively small size; or difficult to distinguish from one another due to common design features. Because the aforementioned visually distinctive features are readily distinguishable from design features common to many conventional mobile hand-held electronic devices, an apparatus according to the invention advantageously minimizes the risk of loss of valuable personal property.

Fastener 104, represented in FIG. 1 as a double-arrowed line, may be any apparatus or system capable of securely fastening a body 102 to a device 106. Examples of fasteners include glue, thread, tape, string, rivets, pins, screws, clips, or other fasteners or bonding agents. In one embodiment, fastener 104 is a releasable fastener, which means that once fastened, a user may easily release fastener 104 by hand without the need for a key or other tool. Examples of releasable fasteners for attaching body 102 to a device 106 include one or more strips of a Velcro® hook and loop type fastener, one or more elastic straps, one or more lockable rotating fasteners, one or more buttons, zippers, magnets, releasable clips, and the like. (For more information on Velcro® hook and loop type fasteners, refer to http://www.velcro.com.) Accordingly, fastener 104 may comprise one or more subcomponents permanently or removably attached to a device 106, or permanently or removably attached to both body 102 and device 106. In another embodiment, a removable fastener 104 comprises a pocket located on body 102, wherein the pocket is sized for accommodating at least a portion of device 106 snugly. For example, such a pocket may be sewn onto a padded or stuffed fabric that comprises an outer covering for body 102. By providing a removable fastener 104, a user may remove a body 102 from a device 106 whenever it is advantageous to maintain a device 106 in as small a package as possible.

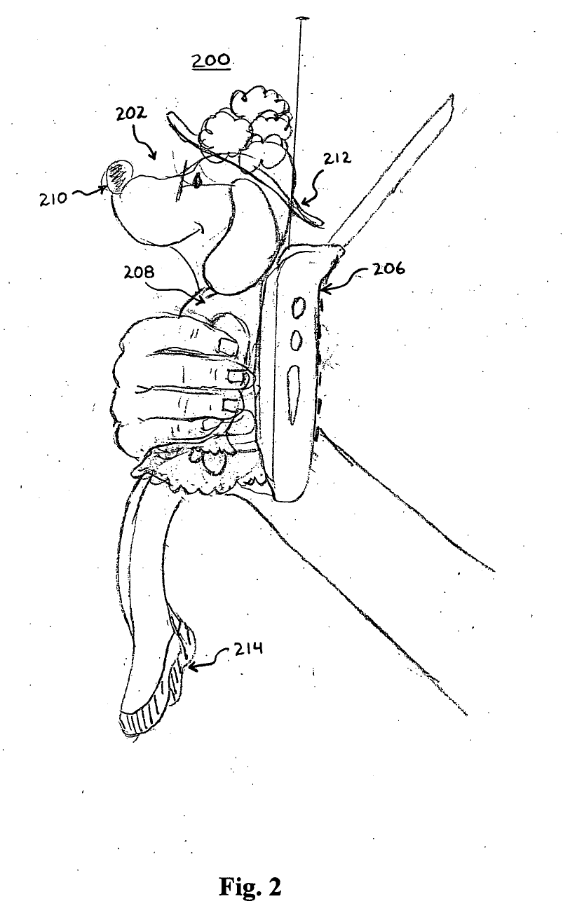

FIG. 2 illustrates an embodiment of an apparatus according to the invention attached to a cellular telephone 206. Apparatus 200 comprises a body 202 in the form of a stuffed animal, or stuffed character, and a fastener 204 (not shown) for attaching body 202 to telephone 206. As shown, body 202 forms a distinctive irregular shape, about two to three times as bulky as cell phone 206. In this embodiment, fastener 204 comprises a conventional Velcro® fastener affixed to body 202 and cell phone 206. A first Velcro® strip, comprising a plurality of small plastic hooks, is glued to the back of body 202 (the back of the stuffed character) by an adhesive such as an epoxy-based glue. Similarly, a second, complimentary Velcro® strip comprising looped fabric is glued to the back of cell phone 206. By mating the hooks on the back of body 202 to the looped fabric on the back of device 206, body 202 becomes securely and removably attached to device 206, as shown in FIG. 2.

Body 202 is formed from an outer covering comprising a fabric such as polyester, and is stuffed with small pellets made of a plastic such as polycarbonate. Body 202 also comprises a generally cylindrical portion 208, i.e., the trunk section of the stuffed character. Cylindrical portion 208 is about two to four inches in diameter, and thereby provides a user with an ergonomically sound location for grasping telephone 206. In addition, the deformable, resilient quality of the stuffed polyester fabric is ergonomically well suited for secure grasping. Furthermore, the outer covering of body 202 comprises various colored sections that are visually distinctive, such as the trunk section 208, nose 210, hat 212, and shoes 214. The combination of the distinctive irregular shape and visually distinctive colors make body 202 readily recognizable to a user searching from afar, thereby facilitating the user identifying and locating the attached device 206.

In another embodiment, one or more features of a body 202 are made visually distinctive by use of one or more patterns of bright colors, in particular, bright complimentary colors. A body 202 having an outer layer comprising one or more patterns of bright complimentary colors ergonomically attracts the human eye to aid a user in locating a device 206 attached thereto. In other words, a bright complimentary color pattern at least partially covering a body 202 causes it to stand out conspicuously against a background of ambient colors—in effect, performing a function opposite that of camouflage. A pattern of complimentary colors may comprise any of one of the following color pairs: green and red; blue and orange; purple and yellow. Learned artisans will appreciate that in addition to these three, other complimentary color pairs are possible.

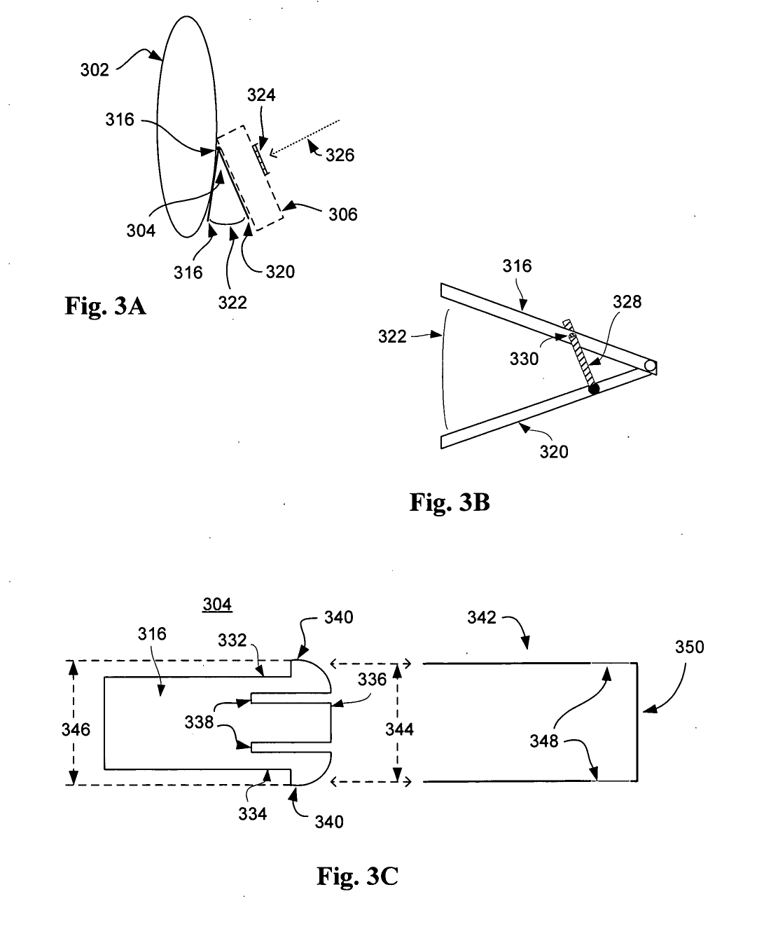

FIG. 3A illustrates another embodiment according to the invention. In this embodiment, a body 302 attaches to a device 306 by means of a clip 304. Clip 304 comprises a first member 316 attached at a proximal end 318 to a second member 320. In the embodiment shown, members 316 and 318 diverge from end 318 to form an angle 322 between them. In one example, angle 322 is fixed; in another example, angle 322 is adjustable. First member 316 attaches to body 302, and second member 320 attaches to device 306, by any conventional fastening means such as glue, thread, tape, string, rivets, pins, screws, clips, or other fasteners or bonding agents. So fastened, clip 304 attaches device 306 to body 302 at an angle 322, as shown. With this embodiment, a user may position body 302 on a horizontal surface (such as a tabletop) such that a user interface 324 on device 306 may be displayed in a direction facing normal to the user's line of sight 326. This angular presentation is particularly advantageous where interface 324 includes an LCD or similar visual display that cannot be seen clearly unless viewed straight on. In another application of this embodiment, a user may hang body 302 on a vertical surface, or suspend body 302 vertically (for example, from a rearview mirror), and similarly present interface 324 of device 306 directly into the line of sight of a downward looking user. In another embodiment, angle 322 is adjustable between about 0 and about 90 degrees. In another embodiment, angle 322 is adjustable to between about 0 and about 180 degrees.

FIG. 3B shows a detailed side view of one embodiment of a clip 304. A means for adjusting angle 322 is provided by a spring 328 extending from second member 320 and disposed between first member 316 and second member 320. In one form, spring 328 may comprise a flexible metal or plastic tab that maintains a desired angle 322 by friction fit within an accommodating hole or groove 330 cut into first member 316.

FIG. 3C shows a frontal view of an embodiment of a clip 304. First member 316 is shown; however, second member 320 could also be configured according to FIG. 3C. In this embodiment, second member 320 (not shown) is fastened to body 302 by any of the aforementioned conventional fasteners. A first spring 332 and a second spring 334 are cut into the distal end of first member 316, each spring 332 and 334 separated from the center section 336 of first member 316 by a gap 338. A snap hook 340 is formed at the end of each spring 332 and 334 as shown. A locking channel 342 is configured to mate with, and releasably lock onto the distal end of first member 316. Locking channel 342 is a separate part that attaches by any conventional fastener to a body 302. The width 344 of locking channel 342 is slightly less than the maximum width 346 measured across snap hooks 340. To lock clip 304 onto body 302, a user slides first member 316 within locking channel 342, thereby forcing springs 332 and 334 inward, until hooks 340 protrude from openings 348 in channel 342. At that point, the restoring force of springs 332 and 334 cause snap hooks 340 to extend outward, thereby locking hooks 340 into a position in openings 348 to prevent retraction of first member 316. Further insertion of first member 316 is prevented by abutment of its distal end against end wall 350. In this fashion, a body 302 may be releasably attached to a device 306.

To release first member 316 from its locked position, a user pushes springs 332 and 334 inward until hooks 340 release to allow retraction of first member 316 from channel 342. Skilled artisans will appreciate that other releasable locking configurations are possible, that one or both of first and second members 316 and 320 may be so configured, and that one of members 316 and 320 not so configured may be attached to a body 302 or device 306 by other fastening means such as any of those previously described. For example, another releasable locking configuration may comprise a member having a single spring-loaded button that locks into an accommodating hole cut into a side of the locking channel.

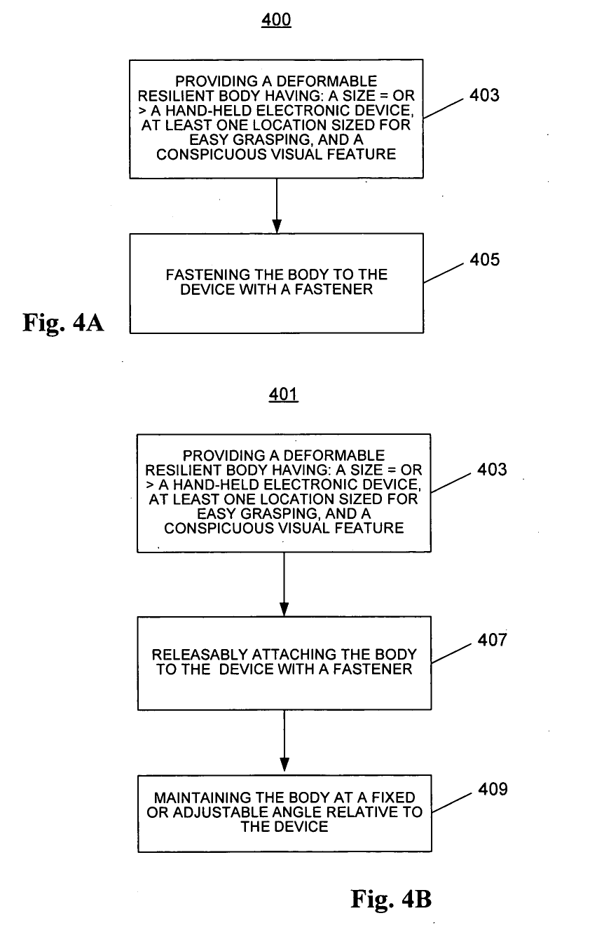

FIG. 4A illustrates one embodiment of a method according to the invention. Method 400 begins with step 403, comprising providing a deformable resilient body, the body having (a) a size approximately equal to or greater than a mobile hand-held electronic device, (b) at least one location dimensionally suited for easy grasping by a human hand, and (c) at least one conspicuous visual feature that is easily recognizable. Various terms in substeps (a)-(c) are interpreted as in previously described embodiments. The next and final step is step 405, comprising fastening the body to the device with a fastener. By performing the foregoing steps, a user may enhance an existing product with ergonomic features that overcome various problems attributable to size reductions in mobile hand-held electronic devices.

FIG. 4B illustrates another embodiment of a method according to the invention. Method 401 begins with step 403, which is identical to step 403 previously discussed. The next step is step 407, which comprises releasably attaching the body to the mobile hand-held electronic device with a fastener. Any of the foregoing various releasably attachable fasteners may be employed during this step. Final step 409 comprises maintaining the body at an angle relative to the device. A clip having first and second angled members may fix the angle, for example, or the angle may be adjustable using a suitable adjustable angle clip or fastener.

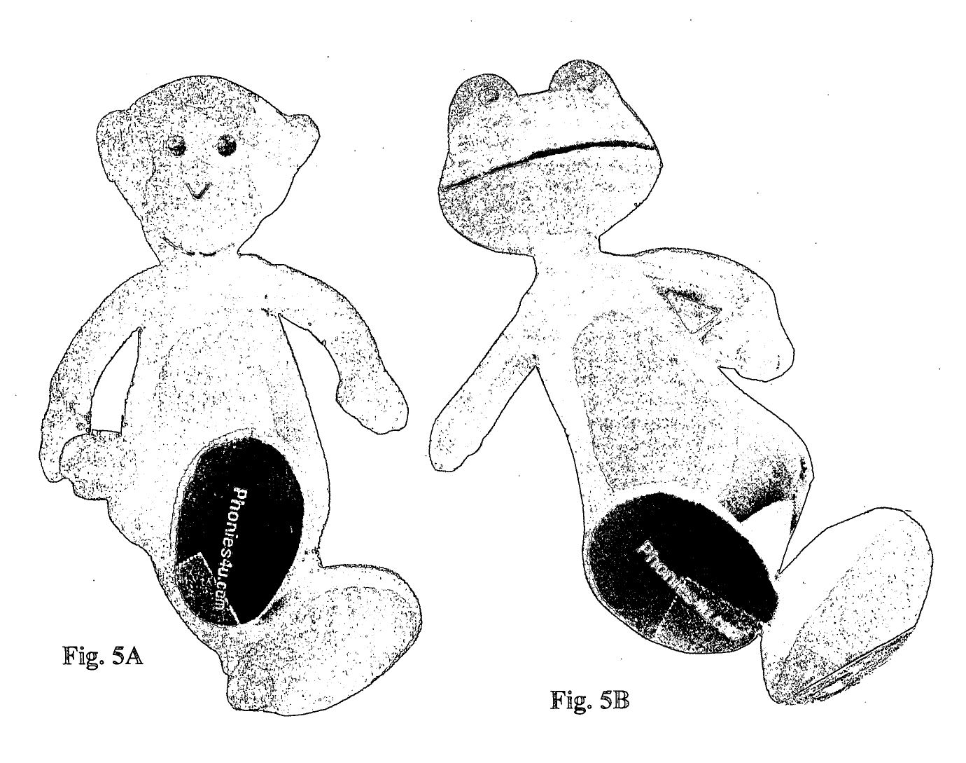

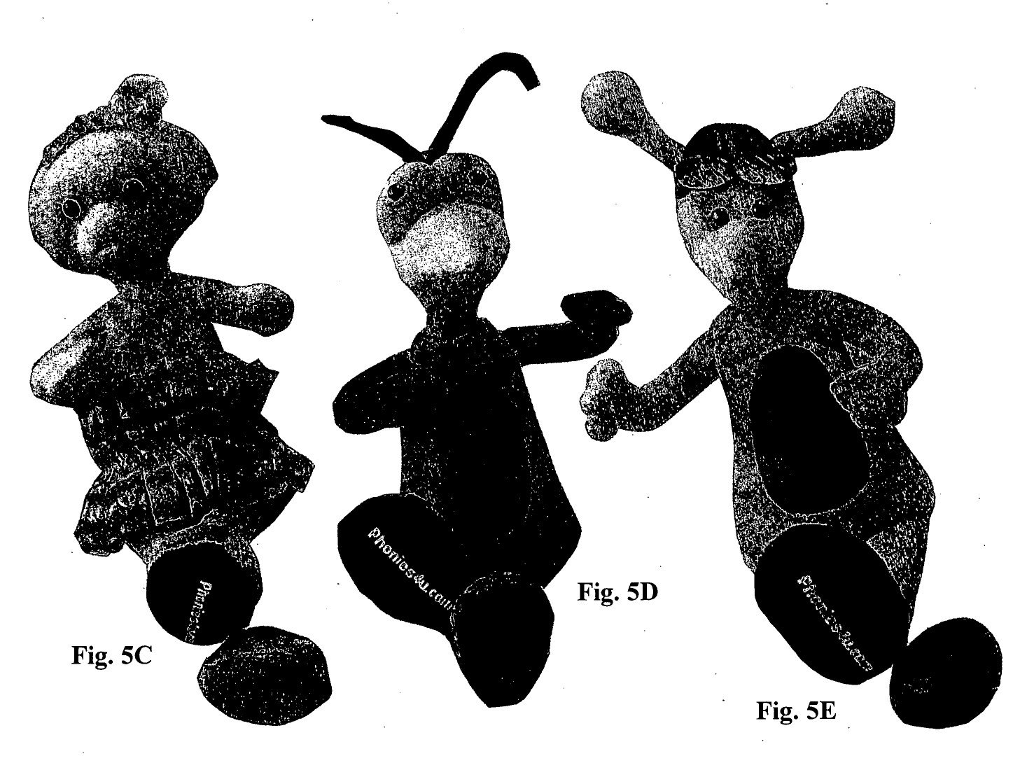

FIGS. 5A-5E depict various embodiments of a body 102. These embodiments are presented in an exemplary, rather than a limiting sense. Each embodiment comprises a stuffed humanoid or animal having a deformable resilient body. FIG. 5A depicts a body 102 in the form of a monkey; FIG. 5B, a frog; FIG. 5C, a humanoid doll; FIG. 5D, a bug; and FIG. 5E, a dog. Each body is sized to provide at least one location for easy grasping by a user's hand. Each body further provides at least one conspicuous visual feature, such as an irregular geometry or shape, an eye-catching humanoid form or caricature, and/or one or more bright colors or complimentary color combinations. Although these colors are not apparent in the monochromatic drawing, they may be easily inferred from the shading variations, for example, as shown in the polka-dot pattern in the belly region of the bug of FIG. 5D. Each of these embodiments also advantageously provides protective padding to guard or cushion a device 106 in the event it is dropped.

Many variations on an apparatus according to the invention are possible, and many accessories may be added for the convenience of a user. For example, one or more zippered pockets may be added to the body 102 for storing device accessories or other personal property. The body 102 may be convertible into a carrying bag, whereby the bag, when not in use, may be stuffed into one of the pockets, and when in use, may be formed again by turning the pocket inside out. The bag may integral to the body, i.e. sewn into the lining of the body 102, and provide sufficient volume to carry personal accessories much like a purse.

Other variations are possible. For example, the bag described in the previous paragraph may be formed of a waterproof material sufficient for storing liquid. In another embodiment, a body 102 may function as a canteen, wine skin, or bota bag.

In still another variation, a body 102 may provide a storage area (such as inside the head of a stuffed humanoid or animal body) for storing computerized electronics that interfaces to a device 106. The electronics may be programmed to produce a sound responsive to the device 106 receiving a signal such as an incoming phone call. A speaker coupled to the electronics and integral to body 102 may be configured to project the sound. In one embodiment, the sound is representative of the stuffed humanoid or animal. For example, a monkey scream may be associated with a monkey body 102; a ribbit sound may be associated with a frog body 102; a cadence of football audibles may be associated with a humanoid quarterback.

The invention has been presented in an illustrative style. The various terminology employed throughout should be read in an exemplary rather than a limiting manner. Although some disclosure has been provided for dimensions of various components, other details and dimensional relationships that have not been fully described may be easily ascertained by those skilled in the art after a thorough reading of the disclosure. Accordingly, the present invention may be practiced in ways other than as specifically described herein.

1. An apparatus for attachment to a mobile hand-held electronic device, comprising:
a body having a size approximately equal to or greater than the device, and at least one location dimensionally suited for easy grasping by hand; and
a fastener for attaching the body to the device.

2. The apparatus of claim 1 wherein the body further comprises a visually conspicuous feature.

3. The apparatus of claim 2 wherein the feature is a selected from the group comprising color, shape, humanoid form, and complimentary color combination.

4. The apparatus of claim 1 wherein the body comprises a deformable, resilient material.

5. The apparatus of claim 4 wherein the body comprises a stuffed fabric.

6. The apparatus of claim 1 wherein the fastener is releasably attachable to at least one of the body and the device.

7. The apparatus of claim 6 wherein the fastener is selected from the group comprising a hook and loop type fastener, a releasable attachable clip, and a pocket attached to the body for accommodating at least a portion of the device.

8. The apparatus of claim 1 wherein the fastener maintains the body at a fixed angle relative to the device.

9. The apparatus of claim 1 wherein the fastener maintains the body at an adjustable angle relative to the device.

10. An ergonomic apparatus for attachment to a cell phone, comprising:
a deformable resilient body having
a size approximately equal to or greater than the device,
at least one location dimensionally suited for easy grasping by hand,
conspicuous form and color providing easy visual identification; and
a releasably attachable fastener for attaching the body to the cell phone.

11. The apparatus of claim 10 wherein the fastener comprises a hook and loop type fastener.

12. The apparatus of claim 10 wherein the fastener maintains the body at a fixed angle relative to the cell phone.

13. The apparatus of claim 10 wherein the fastener maintains the body at an adjustable angle relative to the cell phone.

14. The apparatus of claim 10 wherein the fastener is releasably attachable to at least one of the body and the cell phone.

15. The apparatus of claim 10 wherein the fastener comprises a pocket attached to the body for accommodating at least a portion of the cell phone.

16. A method for facilitating handling and visual identification of a mobile hand-held device, comprising:
providing a deformable, resilient body having
a size approximately equal to or greater than the device,
at least one location dimensionally suited for easy grasping by a human hand, and
a conspicuous visual feature; and
fastening the body to the device with a fastener.

17. The method of claim 16 wherein the feature is a selected from the group comprising bright color, irregular shape, humanoid form, and complimentary color combination.

18. The method of claim 16 wherein the fastening step comprises releasably attaching the body to the device.

19. The method of claim 18 wherein the fastener comprises a hook and loop type fastener.

20. The method of claim 18 wherein the fastener comprises a pocket for accommodating at least a portion of the device.

21. The method of claim 16 further comprising maintaining the body at a fixed angle relative to the device.

22. The method of claim 16 further comprising maintaining the body at an adjustable angle relative to the device.

23. The method of claim 22 wherein the fastener comprises a clip having two members separable by an adjustable angle.

24. The method of claim 22 wherein the fastener is releasably attachable to at least one of the body and the device.
